(19) United States
(12) Patent Application Publication
(10) Pub. No.: US 2006/0085169 A1
(43) Pub. Date: Apr. 20, 2006

(54) Analytical system, collection of information used in the system, and recording medium storing the collection of information

(75) Inventor: Shigeaki Shibamoto, Kyoto-shi (JP)

Correspondence Address: KANESAKA BERNER AND PARTNERS LLP, SUITE 300, 1700 DIAGONAL RD, ALEXANDRIA, VA, 22314-2848, US

(73) Assignee: SHIMADZU CORPORATION, Kyoto-shi (JP)

(21) Appl. No.: 11/239,217

(22) Filed: Sep. 30, 2005

(30) Foreign Application Priority Data
Oct. 6, 2004 (JP) 2004-293268

(51) Int. Cl. G06F 15/00

(52) U.S. Cl. 702/189

(57) ABSTRACT

An analytical system includes an analytical unit, and a control unit for controlling operation of the analytical unit. The control unit includes a inspecting function for reviewing stored analysis datasets. The datasets include analysis condition files having analysis conditions that correspond to analysis examples, and operating portions for selecting the analysis condition files. The control unit includes an operation detecting device for detecting the operator's selection, and a file extracting device for extracting and saving in a predetermined memory location the analysis condition file. The analytical unit performs the analysis by utilizing the saved analysis condition file. The analysis datasets may be stored in a storage medium that is inserted into the control unit, or in a built-in storage device. The system eliminates the inconvenience of requiring entry of analysis conditions item by item, and eliminates the possibility of entering erroneous analysis conditions.

### BACKGROUND OF THE INVENTION AND RELATED ART STATEMENT

The present invention relates to analytical systems for conducting analyses using various analytical apparatuses, including gas chromatographs. The present invention also relates to collections of information used in the analytical systems, and to recording media storing the information collections.

To analytical apparatus manufacturers, it is very important to provide prospective purchasers of apparatuses, including gas chromatographs, with information regarding system requirements that will allow the users to analyze samples they wish to analyze. It is also important to provide users who have already purchased analytical apparatuses with information regarding appropriate conditions for analyzing samples with which the users may have no experience. For such various purposes, apparatus manufacturers have conventionally provided users with analysis datasets in a booklet format, free of charge or for a fee. Analysis datasets refers to a collection of analysis examples summarizing the actual conditions (including system configuration) of the analysis examples, and the results of analyzing various samples using an apparatus (or system). See, for example, the description in “Datasets/Technical Reference Material GC/GCMS,” [online] Shimadzu Corporation, [retrieved on 2004-09-28]. Retrieved from Internet: <URL: http://www.an.shimadzu.co.jp/support/lib/data/data1.htm>.

In recent years, such analysis datasets, which had conventionally been provided in a booklet format, have increasingly been provided in an electronic file format, such as a PDF (portable document format). More specifically, the electronic files containing analysis datasets are often stored in a recording medium, such as a CD-ROM, for distribution to users, or made available in a downloadable format on the Internet. In either case, users can thoroughly review the electronic files displayed on the screen of their personal computers by utilizing appropriate software.

When a user who has purchased an apparatus wishes to analyze a sample he has never analyzed before, he can search for an analysis example for that sample in analysis datasets using his personal computer. If the user wishes to perform the same analysis as one found, he can enter and set the conditions for the analysis in the apparatus (or, in the computer that controls the apparatus). However, entering the conditions item by item is a painstaking task because a gas chromatograph requires numerous conditions to be set. In addition, erroneous entries tend to be made when setting conditions that are expressed in small numbers.

In a conventional system such as that disclosed in Domestic Republication No. WO 2002/068963, the results of the analyses conducted by a number of individuals and organizations are registered in a database made available in an administrator's server. When a user enters search criteria, including a sample name, using his personal computer, the database is accessed through the Internet, and information accumulated in the database, such as analysis results, is extracted. The analysis conditions can then be downloaded to the computer as needed. The analysis conditions for the analysis example compiled in the server can be obtained as an analysis condition file so that the user does not have to enter the conditions item by item.

The analysis condition files in the aforementioned conventional system, however, cannot be obtained unless the personal computer that controls the analytical apparatus has access to the Internet, and thus various restrictions related to the operating environment exist. Even if the operating environment is such that the personal computer has access to the Internet, it may not necessarily have access to the Internet at all times. If the computer does not have access to the Internet at all times, searching for, or inspecting analysis examples online, would be difficult.

In addition, for those who have been accustomed to analysis datasets in the conventional booklet format and/or have limited skills in operating a computer, thumbing through pages or searching from the table of contents is often preferred to entering search criteria on the computer by following various data input rules.

Moreover, when analytical apparatus manufacturers provide numerous users with analysis datasets, ensuring the reliability of the datasets is extremely important, in addition to offering an ample number of examples. In the aforementioned conventional system, however, ensuring the reliability of the database is difficult since numerous individuals and organizations are allowed to register collected analysis examples into the database in the administrator's server.

The present invention has been developed to address the above-described problems associated with conventional systems. A first object of the present invention is to provide an analytical system capable of performing an analysis selected by a user from among the analysis datasets provided by an apparatus manufacturer with simple operations and under accurate analysis conditions. A second object of the present invention is to provide a collection of information comprising data constituting analysis datasets for use in the analytical system. A third object of the present invention is to provide an easy-to-handle recording medium which contains the collection of information.

Further objects and advantages of the invention will be apparent from the following description of the invention and the associated drawings.

### SUMMARY OF THE INVENTION

The present invention, which achieves the aforementioned objects, comprises an analytical unit, and a control unit for controlling the operation of the analytical unit. The control unit includes an inspecting function for reviewing stored analysis datasets. The analysis datasets may be stored in a storage medium that is inserted into the control unit, or in a built-in storage means. The analysis datasets comprise analysis condition files, which include analysis conditions for analysis examples as data, embedded therein so as to correspond with respective analysis examples. The analysis datasets also include an operating portion, i.e., a button, located within the display of each analysis example for extracting the corresponding analysis condition file.

The control unit also comprises an operation detecting means for detecting the operation of the button while the analysis datasets are displayed, and a file extracting means for extracting the analysis condition file corresponding to the analysis example in which the operation is executed. The file extracting means then saves the analysis condition file in a predetermined memory location as the analysis conditions for use by the analytical unit. The analytical unit performs the analysis by utilizing the analysis condition file saved in the predetermined memory location by the file extracting means.

Using the control unit, a user searches a target analysis example while inspecting the description of each analysis example in the analysis datasets displayed on the computer monitor. When the analysis example the user wishes to trace is found, he can click the operating button on the screen displaying the analysis example. The operation detecting means detects the operation, and the file extracting means fetches the analysis condition file corresponding to the operation button from among the data constituting the analysis datasets to be saved in a predetermined memory location in the control unit, i.e., generally a folder designated for saving analysis conditions.

Such analysis datasets are stored on a recording medium, such as, for example, a CD-ROM or a DVD-ROM, or on a hard disk inside or outside of the control unit. The actual processing performed by the file extracting means is to extract only the target analysis condition file and copy that to a predetermined, separate memory location. When performing the analysis on the analytical system, setting the analysis condition file saved in the predetermined memory location of the control unit as the analysis conditions for the analysis as described above enables an error-free execution of the analysis in accordance with the analysis condition data contained in the analysis condition file.

The system according to the present invention eliminates the inconvenience of requiring an operator to enter the analysis conditions item by item, as was the case with conventional systems, when the operator desires to conduct the same analysis as an analysis example found in the analysis datasets. This saves the operator effort, and eliminates the possibility of entering erroneous analysis conditions, which would render the analysis worthless.

In addition, users can search analysis examples with the ease of the conventional booklet format for analysis datasets, as well as extracting analysis condition files and copying into a predetermined memory location, with a simple operation. Thus, even those who are accustomed to booklet format datasets, or are not fully skilled in computer operation, can easily handle the operation of the system according to the present invention.

Since all of the data constituting the analysis datasets are stored in one location, i.e., on the aforementioned recording medium, or on an internal or external hard disk, a user can carry out tasks even if the control unit has no access to the Internet. Even if Internet access is available, the user can take the time to view the files off-line.

The electronic file format of the collection of information comprising the data constituting analysis datasets used in the analytical system of the present invention is not particularly limited, but a PDF or an HTML format is generally convenient. To tie each analysis example with a corresponding analysis condition file, a function to embed, i.e., attach, a file, for example, can be used for the PDF format, and a function to create a link can be used for the HTML format.

As described above, the collection of information comprising the data constituting analysis datasets may be stored on a portable recording medium or on a hard disk built into the control unit. When stored on a computer-readable portable recording medium, the same tasks can be performed in any computer (as long as it is compatible with the control unit in the present invention) using the recording medium. Write protecting the recording medium, in particular, can prevent the user from inadvertently deleting data contained in the analysis datasets, or modifying or adding contents, thereby ensuring the reliability of the data.

### BRIEF DESCRIPTION OF THE DRAWINGS

FIG. 1 is a schematic diagram illustrating the overall configuration of a gas chromatography analytical system according to one embodiment of the present invention.

FIG. 2 is a process flowchart for a typical processing operation performed by the gas chromatography system.

FIG. 3 illustrates an analysis example selected from an analysis dataset displayed on a system monitor.

FIG. 4 illustrates an example of a pull-down menu displayed when a system “Method Download” button is operated.

FIG. 5 illustrates an example of a window for selecting a location in which to save an extracted file.

### DETAILED DESCRIPTION OF THE PREFERRED EMBODIMENTS

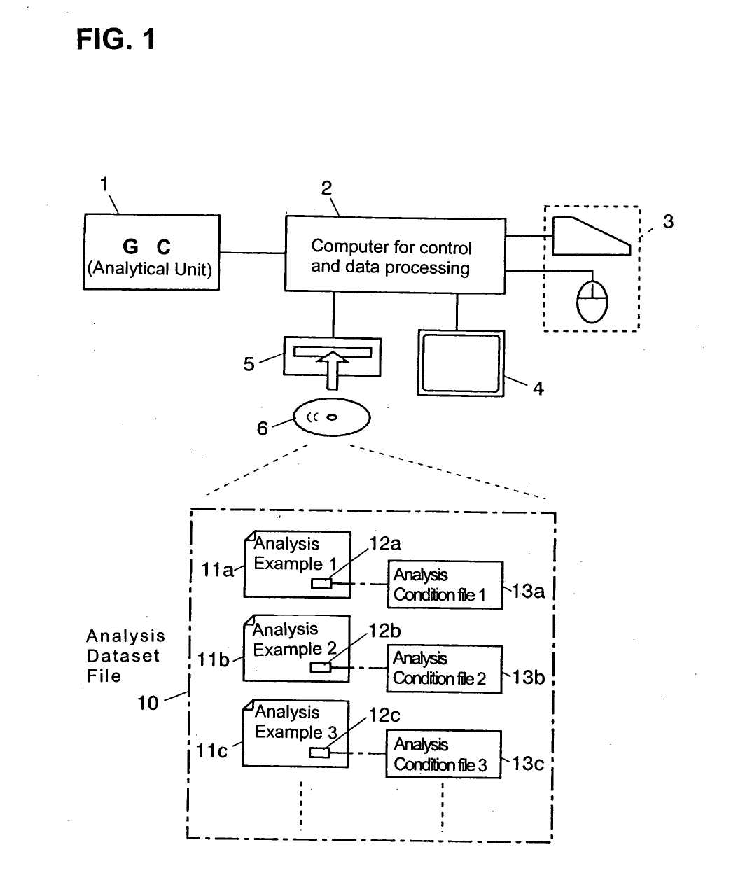

In the following description, an analytical system according to one preferred embodiment of the present invention will be explained with reference to the accompanying drawings. In this embodiment, the analytical system of the present invention is applied to a gas chromatography system. FIG. 1 illustrates an overall system configuration of a gas chromatography (“GC”) system.

The GC unit 1, which performs gas chromatograph analyses on samples, includes a sample vaporization chamber, a column oven with a column installed therein, a detector, and the associated apparatus (not shown). The data obtained by the GC unit 1 are transmitted to a computer 2 for operation control and data processing. The computer 2 is a general purpose personal computer, and software for controlling the operation and processing data is installed therein. The operation of the GC unit 1 is controlled and the data processed by executing the software. Operating devices 3, such as a keyboard and a mouse, a display 4, a CD drive 5 and the like, are connected to the computer 2.

The configuration, however, is not limited to that shown in FIG. 1. For example, the display unit 4 and the CD drive 5 may be integrated into the main computer body (i.e., built-in), depending on the form of the computer.

In order for the analytical system to achieve the functions described herein, analysis datasets are used that are provided in a CD-ROM format by, for example, the manufacturer of the GC unit 1. That is, the analysis datasets for the GC unit 1 are stored on the CD-ROM 6 in an electronic file format (illustrated as analysis dataset file 10).

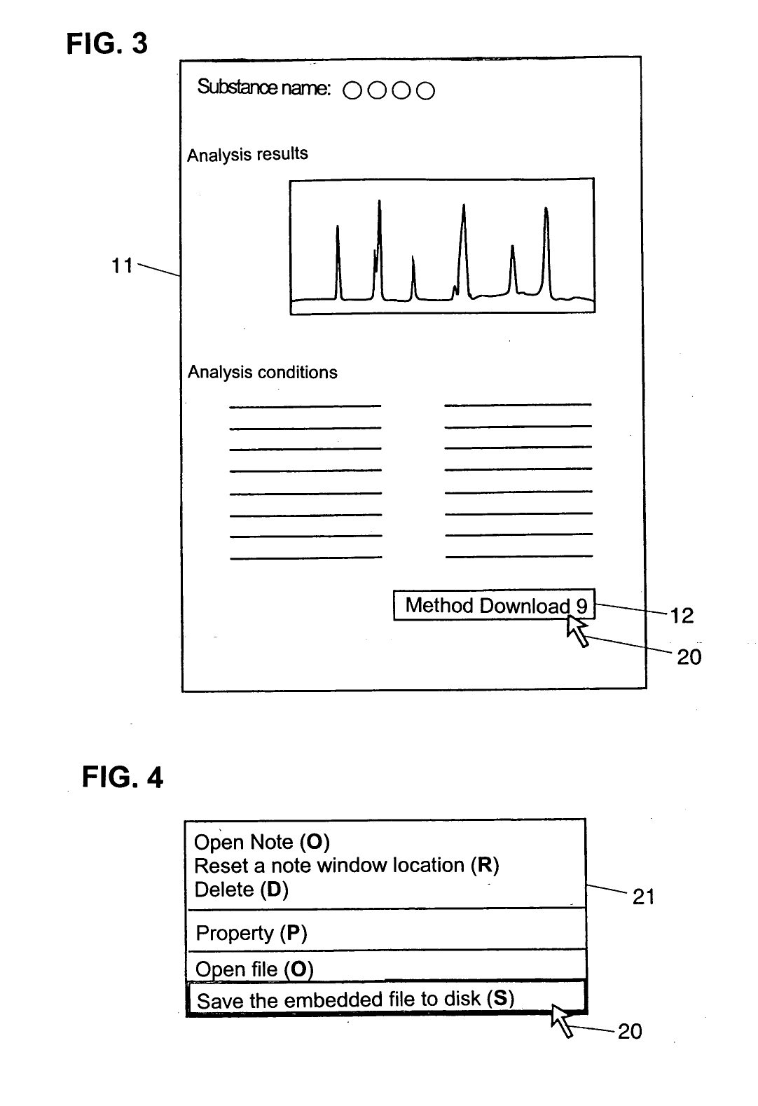

Analysis datasets summarize analysis conditions and resultant chromatograms as analysis examples for individual samples. For example, the description of one analysis example is one-to two-pages long, as shown in FIG. 3. The analysis dataset file 10 is created in a PDF format in this example, but may take other formats, including HTML. In the HTML format, however, analysis datasets should not be included in one file, and thus an analysis dataset folder is created, rather than an analysis dataset file.

Conventionally, analysis datasets were such that the printed analysis datasets were simply converted into an electronic file, and thus were only available for viewing on the personal computer screen. The analysis dataset file 10 stored on the CD-ROM 6 used in the analytical system of the present invention, however, has characteristics in the data structure itself. As shown in FIG. 1, for analysis examples lla, llb, llc . . . , analysis condition files 13a, 13b, 13c . . . , which include the condition data, are respectively embedded. The individual descriptions of the analysis examples lla, llb, llc . . . include “Method Download” buttons 12a, 12b, 12c . . . disposed therein to link to the respective condition files 13a, 13b, 13c . . . . The analysis condition files 13a, 13b, 13c . . . are in PDF format in this example, and thus they are embedded files (i.e., the same as attached files). For HTML format, links can be created to files in separate locations. In either case, the files need only have a one-to-one link.

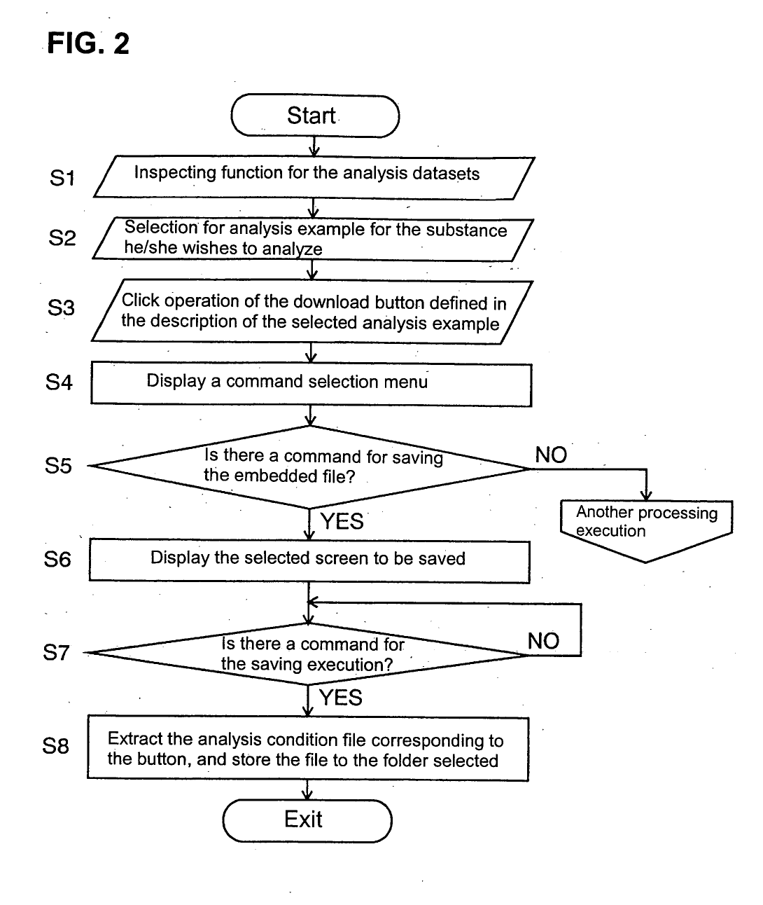

A typical processing performed by the analytical system using the analytical dataset file 10, which has the aforementioned characteristics, will be explained with reference to FIGS. 2-5. FIG. 2 is a flowchart of the operation and processing; FIGS. 3-5 are examples of displays appearing on the display unit 4.

An operator inserts the CD-ROM 6 into the CD drive 5, and displays the analysis datasets on the display unit 4 using application software for viewing the PDF files (such as, e.g., software sold under the registered trademark ADOBE ACROBAT, or the like). FIG. 3 shows an analysis example displayed on the display unit 4. The operator views analysis examples by sequentially turning the pages, for example, (step S1), and selects the analysis example for the substance he wishes to analyze (step S2).

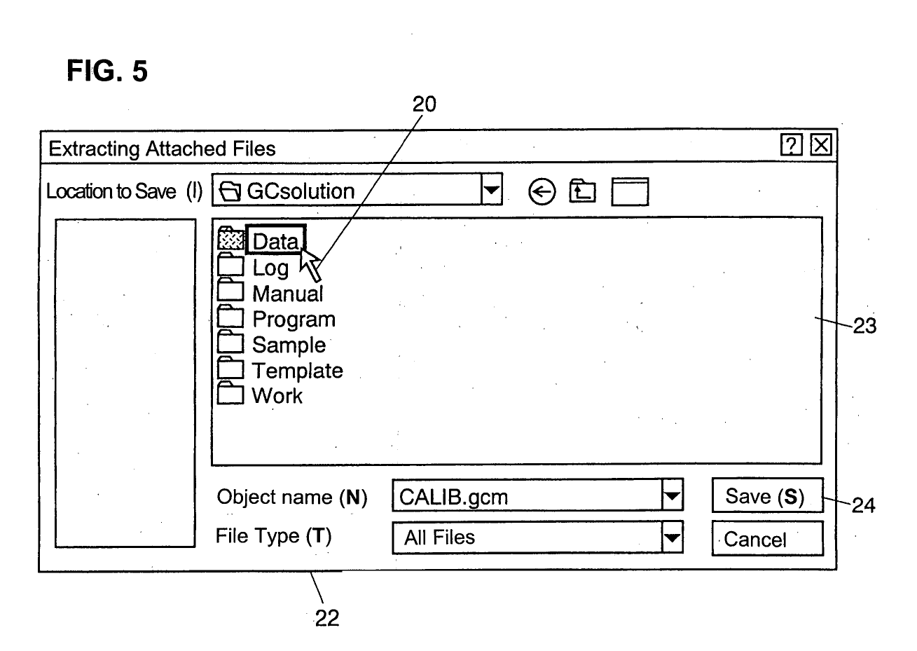

To utilize the analysis conditions of the analysis example to analyze the sample, i.e., trace the analysis on the GC unit 1, the operator moves the cursor 20 onto the “Method Download” button 12 defined in the description of the selected analysis example 11 displayed on the screen, as shown in FIG. 3, and executes a right-click operation of the mouse (input device 3) (step S3). In response to this operation, the computer 2 will display the pull-down menu 21, such as that shown in FIG. 4, as a command selection menu, in the vicinity of the “Method Download” button 12 (step S4). To extract the analysis conditions, the operator selects and clicks on the “Save the embedded file to the disk” option in the pull-down menu 21. Once the computer 2 determines that a command was given to save the embedded file (YES in step S5), it displays the saving location selection window 22, as shown in FIG. 5, superimposed on the analysis example 11 displayed on the screen (step S6).

The saving location selection window 22 displays a list of locations 23 available for saving the analysis condition file. Upon selecting a folder from among the list of locations 23, the operator clicks the “Save” button 24. In the example shown in FIG. 5, the “Data” folder, which is a subfolder of the “GC solution” folder, is selected as the location for saving the file. The computer 2 interprets this operation as a command to save the file (YES in step S7), reads out the analysis condition file linked one-to-one to the “Method Download” button 12 operated in step S3 from the CD-ROM 6, and writes it into the folder selected (“Data” folder in this example) (step S8). In general, the memory locations for the folders where files are saved are created in the hard disk built into the computer 2.

When a selection other than the “Save the embedded file to disk” is made in the aforementioned step S5, e.g., “Open file,” another processing in response to the selected command will be executed, the details of which are omitted here.

The processing described above stores the analysis condition file the operator desires to use in the folder selected by the operator. Thus, as long as the operator designates the stored analysis condition file as the file for the analysis when setting the analysis condition file for the GC unit 1, he can execute the GC analysis in accordance with the analysis conditions designated. As described above, a folder to store a file can be freely designated. The folder in which analysis condition files are saved is often predetermined. Thus, the operator can select that folder, or he may create in advance a special folder for saving only analysis condition files.

In the above description, an embodiment in which analysis datasets are stored on a CD-ROM has been disclosed. It should be appreciated, however, that the CD-ROM may be replaced with any other portable recording medium, such as, for example, a DVD-ROM. Moreover, an analysis dataset file may be stored on a hard disk built into the computer 2, instead of on a portable recording medium. In such a case, the analysis condition files stored in a recording medium, such as a CD-ROM, may all be copied onto the hard disk, or the analysis dataset file may be downloaded through the Internet from the analytical apparatus manufacturer's server. Of course, the downloaded analysis dataset file may be stored on a CD-ROM as well. In any case, the analysis dataset file (folder) used in the analytical system in this embodiment is in the possession of a user as a collection of data, and can be used regardless of accessibility to the Internet.

The above-described embodiment is one in which the present invention is applied to a gas chromatography system. It should be appreciated by one skilled in the art, however, that the present invention is applicable to various other systems, such as, for example, a liquid chromatograph, a mass spectrometer, and a spectrophotometer.

Variations and modifications of, and additions to, the foregoing description of the present invention without departing from the spirit of the invention are within the scope of the present invention.

The disclosure of Japanese Patent Application No. 2004-293268 filed on Oct. 6, 2004, is incorporated herein.

What is claimed is:

1. An analytical system comprising:
an analytical unit for performing an analysis of data; and
a control unit for controlling operation of said analytical unit, said control unit comprising:
a storage medium for storing a plurality of analysis datasets,
inspecting means for inspecting said stored plurality of analysis datasets, wherein each of said plurality of analysis datasets comprises analysis condition files having analysis conditions embedded therein, said analysis conditions corresponding to each of a plurality of analysis examples, and an operating portion disposed within said display of each of said analysis examples for selecting a corresponding analysis condition file,
operation detecting means for detecting operation of said operating portion when said corresponding analysis dataset is displayed, and
file extracting means for extracting said selected analysis condition file according to operation of said operation detecting means, and for saving said selected analysis condition file in a predetermined memory location in said control unit so that the analytical unit can perform analysis by using said selected analysis condition file stored in the predetermined memory location by the file extracting means.

2. An analytical system according to claim 1, wherein said storage medium is structurally integral to said control unit.

3. An analytical system according to claim 1, wherein said storage medium is capable of being inserted into said control unit.

4. A collection of analytical information comprising data for constituting said datasets for use in the analytical system according to claim 1.

5. A computer-readable portable recording medium for use in an analytical system storing said collection in claim 4.
